(19) United States
(12) Patent Application Publication
(10) Pub. No.: US 2017/0067472 A1
(43) Pub. Date: Mar. 9, 2017

(54) THRUST BEARING ASSEMBLY INCLUDING LINED BEARING SURFACES

(71) Applicant: BorgWarner Inc., Auburn Hills, MI (US)

(72) Inventors: Andrew DAY, Yorkshire (GB); Tristram PALMER-WHITE, Yorkshire (GB); Sean RYLANCE, Yorkshire (GB); Martin JARVIS, Manchester (GB)

(21) Appl. No.: 15/119,188

(22) PCT Filed: Feb. 12, 2015
(86) PCT No.: PCT/US2015/015602

§ 371 Date: Aug. 16, 2016

Related U.S. Application Data
(60) Provisional application No. 61/944,314, filed on Feb. 25, 2014.

(51) Int. Cl. F04D 29/051; F16C 33/12; F16C 35/02; F04D 29/056; F01D 5/04; F01D 25/16; F04D 29/28; F04D 29/053; F16C 17/04; F02B 33/40

(52) U.S. Cl. CPC F04D 29/051; F16C 17/04; F16C 33/125; F16C 35/02; F02B 33/40; F01D 5/04; F01D 25/162; F04D 29/284; F04D 29/053; F04D 29/056; F16C 2204/12; F16C 2204/14; F16C 2204/22; F16C 2240/70; F16C 2360/24; F05D 2220/40; F05D 2240/52; F05D 2240/60

(57) ABSTRACT

A turbocharger (1) includes compressor and turbine wheels (4, 5) and a shaft (6) that connects the compressor wheel (5) to the turbine wheel (4). The shaft (6) is supported by a thrust bearing assembly (20) that includes a pair of thrust washers (42a, 42b) mounted on the shaft (6), a hollow, cylindrical spacer (80) disposed on the shaft (6) between and abutting first faces (44) of the thrust washers (42a, 42b), and a thrust bearing (100) supported on the spacer (80) between the thrust washers (42a, 42b). One of the thrust bearing (100) or the first and second thrust washers (42a, 42b) includes a copper-alloy lining (60) where the lining (60) is provided in a first region (58a) and in a second region (58b), and the remainder of the thrust bearing (100) or the first and second thrust washers (42a, 42b) is lining free.

### CROSS-REFERENCE TO RELATED APPLICATIONS

This application claims priority to and all the benefits of U.S. Provisional Application No. 61/944,314, filed on Feb. 25, 2014, and entitled “Thrust Bearing Assembly Including Lined Bearing Surfaces,” the contents of which are incorporated herein by reference.

### FIELD OF THE INVENTION

The invention relates to a turbocharger with an improved bearing assembly and more particularly, to a turbocharger thrust bearing assembly including brass or bronze lined thrust washers in conjunction with a steel thrust bearing.

### BACKGROUND OF THE INVENTION

Exhaust gas turbochargers are provided on an engine to deliver air to the engine intake at a greater density than would be possible in a normal aspirated configuration. This allows more fuel to be combusted, thus boosting the engine's horsepower without significantly increasing engine weight.

Generally, an exhaust gas turbocharger includes a turbine section and a compressor section, and uses the exhaust flow from the engine exhaust manifold, which enters the turbine section at a turbine inlet, to drive a turbine wheel located in the turbine housing. The turbine wheel drives a compressor wheel located in the compressor section via a shaft that extends between the sections. Air compressed by the compressor section is then provided to the engine intake as described above. The compressor section of the turbocharger includes the compressor wheel and its associated compressor housing. Filtered air is drawn axially into a compressor air inlet which defines a passage extending axially to the compressor wheel. Rotation of the compressor wheel forces pressurized air flow radially outwardly from the compressor wheel into a compressor volute for subsequent pressurization and flow to the engine.

The forces acting on the compressor wheel and turbine wheel in the axial direction are of differing magnitude, and a thrust bearing is provided on the shaft to provide axial support for the shaft.

### SUMMARY

In some aspects, a washer is formed of a first material, and includes a first face, a second face opposed to the first face, a peripheral edge extending between the first face and the second face along a circumference of the washer, and a through-opening surrounded by the peripheral edge and defining an inner edge. The first face includes a lining of a second material that is different from the first material. The second face is free of a lining of the second material.

The washer may include one or more of the following features: The lining extends between the peripheral edge and an annular, lining-free region that adjoins the inner edge. The peripheral edge has a radius of r1, the lining-free region has a radius of r2, and r2 is less than r1. In addition, the inner edge has a radius of r3, r3 is less than r, and (r1−r2) is approximately 3*(r2−r3). The second material is softer than the first material and has a lower coefficient of friction than the first material. The second material is bronze. The second material is brass. The second material is an aluminum-tin alloy.

In some aspects, a thrust bearing is formed of a first material, and includes a first face, a second face opposed to the first face, a peripheral edge extending between the first face and the second face along a circumference of the thrust bearing, and a through-opening surrounded by the peripheral edge and defining an inner edge. The first face and the second face include a lining of a second material that is different from the first material.

The thrust bearing may include one or more of the following features: A portion of the first face and the second face includes the lining, and the portion extends between the inner edge and an annular, lining-free region that adjoins the peripheral edge. The peripheral edge has a maximum radius of r4, the lining 260 has a radius of r5, and r5 is less than r4. The the inner edge has a radius of r6, r6 is less than r5, and (r4−r5) is approximately 4*(r5−r6). The second material is softer than the first material and has a lower coefficient of friction than the first material. The second material is bronze. The second material is brass. The second material is an aluminum-tin alloy.

In some aspects, a turbocharger includes a compressor wheel; a turbine wheel; a shaft that connects the compressor wheel to the turbine wheel; and a bearing housing that rotatably supports the shaft and includes a thrust bearing assembly. The thrust bearing assembly includes a first thrust washer and a second thrust washer. Each of the first thrust washer and the second thrust washer are mounted on the shaft and formed of a first material. Each of the first thrust washer and the second thrust washer include a first face, and a second face that is opposed to the first face. The thrust bearing assembly includes a hollow, cylindrical spacer disposed on the shaft between the first thrust washer and the second thrust washer. The spacer has a first end that abuts the first face of the first thrust washer and a second end opposed to the first end, the second end abutting the first face of the second thrust washer. The thrust bearing assembly includes a thrust bearing that is formed of the first material and includes a first thrust surface, a second thrust surface that is opposed to the first thrust surface, and a center through-opening that is dimensioned to correspond to an outer diameter of the spacer. The thrust bearing receives the spacer within the through-opening. The first thrust surface and the first face of the first thrust washer abut in a first region, and the second thrust surface and the first face of the second thrust washer abut in a second region. In addition, one of the thrust bearing and the first and second thrust washers includes a lining formed of a second material, where the lining is provided in the first region and in the second region, and the remainder of the thrust bearing or the first and second thrust washers is lining free.

The turbocharger may include one or more of the following features: Each of the first thrust washer and the second thrust washer include a peripheral edge extending between the first face and the second face along a circumference of the thrust washer, and a through-opening surrounded by the peripheral edge and defining an inner edge. The lining is provided on the first face and extends between the peripheral edge and an annular, lining-free region that adjoins the inner edge. The peripheral edge has a radius of r1, the lining-free region has a radius of r2, and r2 is less than r1. The inner edge has a radius of r3, r3 is less than r2, and (r1−r2) is approximately 3*(r2−r3). The spacer first end and spacer second end abut the respective first faces within the lining-free region. The thrust bearing includes a peripheral edge extending between the first thrust surface and the second thrust surface along a circumference of the thrust bearing, and the through-opening is surrounded by the peripheral edge and defines an inner edge. The lining is provided on the first thrust surface and the second thrust surface, and extends between the inner edge and an annular, lining-free region that adjoins the peripheral edge. The peripheral edge has a maximum radius of r4, a region corresponding to the lining has a radius of r5, and r5 is less than r4. The inner edge has a radius of r6, r6 is less than r5, and (r4−r5) is approximately 4*(r5−r6). The spacer is fixed to each of the first thrust washer and the second thrust washer so as to form a pre-assembled unit. The second material is softer than the first material and has a lower coefficient of friction than the first material. The second material is bronze. The second material is brass. The second material is an aluminum-tin alloy.

A thrust bearing assembly for a turbocharger includes a steel thrust bearing in conjunction steel thrust washers having a lining of a material that is soft and has a low coefficient of friction relative to the material used to form the thrust washers. In some embodiments, the material is bronze (e.g., an alloy of 60% to 90% copper and 10% to 40% tin) since the coefficient of friction for bronze alloys against steel ranges between 0.08 and 0.14. During wear, or when there is absolutely no lubricant present, the coefficient of friction may range from about 0.12 to as high as 0.18 to 0.30. By comparison, the coefficient of friction during wear for aluminum on steel is 0.32 and for steel on steel it is 1.00. Alternative materials used for the lining may include brass (e.g., an alloy of about 50% copper and 5% to 40% zinc) or an aluminum-tin alloy. Providing the thrust washers with such a lining is advantageous compared to some conventional turbocharger thrust bearing assemblies in which the thrust bearing and/or the thrust washers are formed entirely of copper since the amount of copper used is greatly reduced, whereby the cost of the thrust bearing assembly is also reduced. In addition, since the thrust bearing is made of steel, it will be more stiff than a conventional copper thrust bearing, allowing more thrust capacity, or alternatively, or a reduction in the axial length of the thrust bearing assembly.

Further advantageously, any wear of the relatively softer lining due to start up, bedding in and/or contaminated lubricant, removes material from the plane thrust surfaces rather than the thrust land surfaces. As a result, the hydrodynamic performance of the thrust land surfaces is not diminished.

The thrust bearing assembly includes a first thrust washer disposed on one side of the thrust bearing, and a second thrust washer disposed on the opposed side of the thrust bearing. Advantageously, the first and second thrust washers are identical, whereby the same part can be used in two locations within the thrust bearing assembly, further simplifying assembly and reducing manufacturing costs.

Within the thrust bearing assembly, the first and second thrust washers are separated by, and adjoin, a thrust bearing spacer. In some implementations, the first thrust washer, the thrust bearing spacer, and the second thrust washer are pre-assembled into a single unit for assembly within the turbocharger. By doing so, it can be ensured that the thrust washers, which include a lining on a portion of the thrust bearing-facing surface thereof, are assembled in the correct orientation within the turbocharger.

Other objects and purposes of the invention, and variations thereof, will be apparent upon reading the following specification and inspecting the accompanying drawings.

### BRIEF DESCRIPTION OF THE DRAWINGS

FIG. 1 is a side sectional view of an exhaust gas turbocharger including a thrust bearing assembly including brass or bronze lined thrust washers in conjunction with a steel thrust bearing.

FIG. 2 is a side view of a portion of FIG. 1 showing an enlarged view of the thrust bearing assembly.

FIG. 3 is a perspective view of a thrust washer showing a lining provided on a portion of the thrust face of the washer.

FIG. 4 is a side sectional view of the thrust bearing assembly of FIG. 1.

FIG. 5 is an exploded perspective view of the thrust washer sub-assembly.

FIG. 6 is perspective view of the assembled thrust washer sub-assembly.

FIG. 7 is a side sectional view of another embodiment thrust bearing assembly.

### DETAILED DESCRIPTION

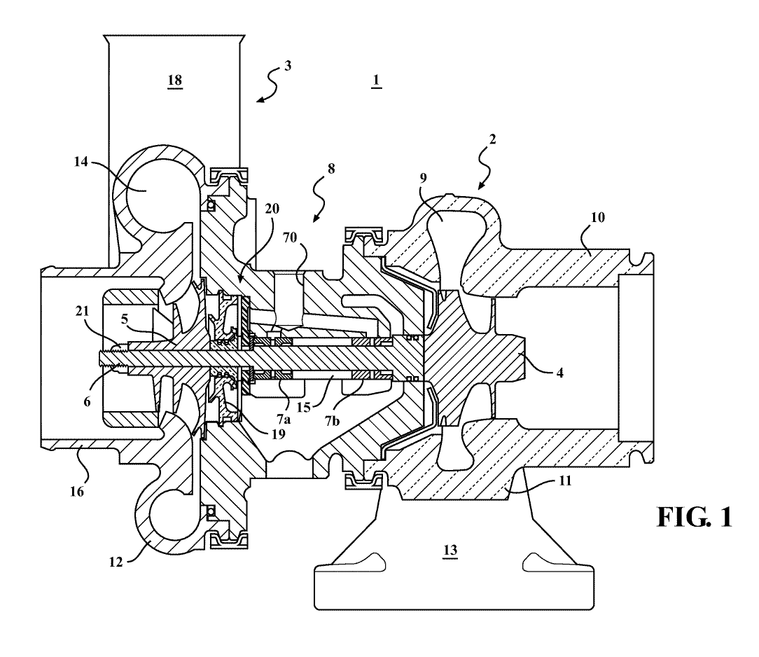

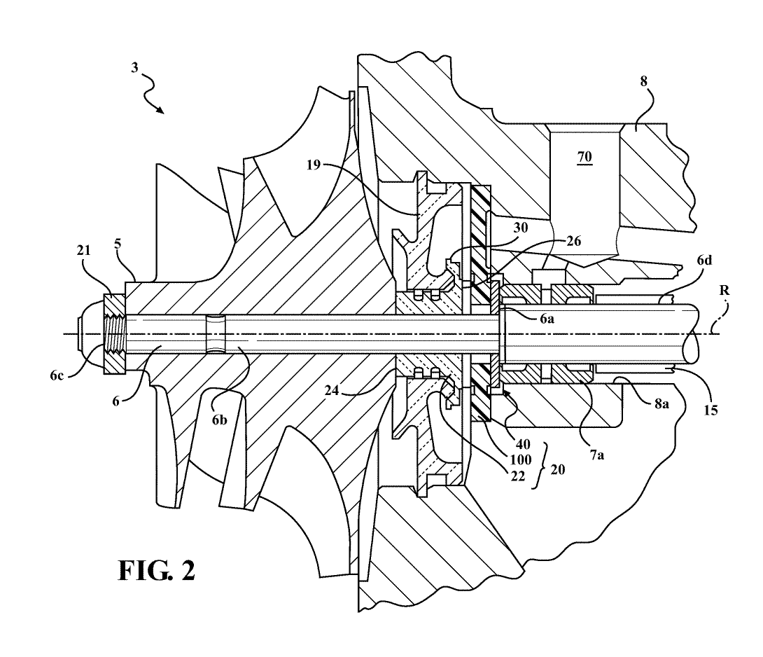

Referring to FIGS. 1 and 2, an exhaust gas turbocharger 1 includes a turbine section 2, the compressor section 3, and a center bearing housing 8 disposed between and connecting the compressor section 3 to the turbine section 2. The turbine section 2 includes a turbine housing 11 that defines an exhaust gas inlet 13, an exhaust gas outlet 10, and a turbine volute 9 disposed in the fluid path between the exhaust gas inlet 13 and exhaust gas outlet 10. A turbine wheel 4 is disposed in the turbine housing 11 between the turbine volute 9 and the exhaust gas outlet 10.

The compressor section 3 includes a compressor housing 12 that defines the air inlet 16, an air outlet 18, and a compressor volute 14. A compressor wheel 5 is disposed in the compressor housing 12 between the air inlet 16 and the compressor volute 14. The compressor wheel 5 is connected to a shaft 6.

The shaft 6 connects the turbine wheel 4 to the compressor wheel 5. The shaft 6 is supported for rotation about a rotational axis R within in the bearing housing 8 via a pair of axially spaced journal bearings 7. For example, a compressor-side journal bearing 7a supports the shaft 6 adjacent the compressor section 3, and a turbine-side journal bearing 7b supports the shaft 6 adjacent to the turbine section 2. The axial spacing between the compressor-side journal bearing 7a and the turbine-side journal bearing 7b is maintained by cylindrical a journal bearing spacer 15. In addition, a thrust bearing assembly 20 is disposed in the bearing housing 8 so as to provide axial support for the shaft 6, as discussed further below.

The shaft 6 is reduced in diameter on the compressor side of the compressor-side journal bearing 7a. As a result, a shoulder 6a is formed in the shaft 6 at this location. The thrust bearing assembly 20 and the compressor wheel 5 are supported on the reduced diameter portion 6b of the shaft 6. The terminal end 6c of the shaft 6 extends beyond the compressor wheel 5 and includes an external thread. A nut 21 engages the threaded portion and is used to retain the compressor wheel 5 on the shaft 6, and to clamp the thrust bearing assembly 20 between the compressor wheel 5 and the shoulder 6a.

In use, the turbine wheel 4 in the turbine housing 11 is rotatably driven by an inflow of exhaust gas supplied from the exhaust manifold of an engine. Since the shaft 6 is rotatably supported in the center bearing housing 8 and connects the turbine wheel 4 to the compressor wheel 5 in the compressor housing 12, the rotation of the turbine wheel 4 causes rotation of the compressor wheel 5. As the compressor wheel 5 rotates, it increases the air mass flow rate, airflow density and air pressure delivered to the engine's cylinders via an outflow from the compressor air outlet 18, which is connected to the engine's air intake manifold (not shown).

A bearing housing cover 19 and the thrust bearing assembly 20 surround the shaft 6 at a location between the compressor wheel 5 and the compressor-side journal bearing 7a. The thrust bearing assembly 20 includes a flinger sleeve 22, a thrust washer sub-assembly 40, and a thrust bearing 100.

The bearing housing cover 19 can be securely sealed to the bearing housing 8, and cooperates with the flinger sleeve 22 to seal oil from the compressor wheel 5 and to keep compressed air from leaking into the bearing housing 8.

The flinger sleeve 22 is surrounded by the bearing housing cover 19 and provides a predetermined axial spacing between the compressor wheel 5 and the thrust washer sub-assembly 40. The flinger sleeve 22 is a hollow cylinder that defines an inner passageway that receives the shaft 6. The flinger sleeve 22 is fixed to the shaft 6, for example by being clamped in the axial direction between the compressor wheel 5 and the thrust bearing assembly 20. A first end 24 of the flinger sleeve 22 abuts a hub of the compressor wheel 5, and an opposed second end 26 of the flinger sleeve 22 abuts the thrust washer sub assembly 40. The outer surface of the second end 26 includes radially-outwardly protruding flanges 30 that fling oil clear of piston rings surrounding the shaft 6, whereby oil leakage is reduced.

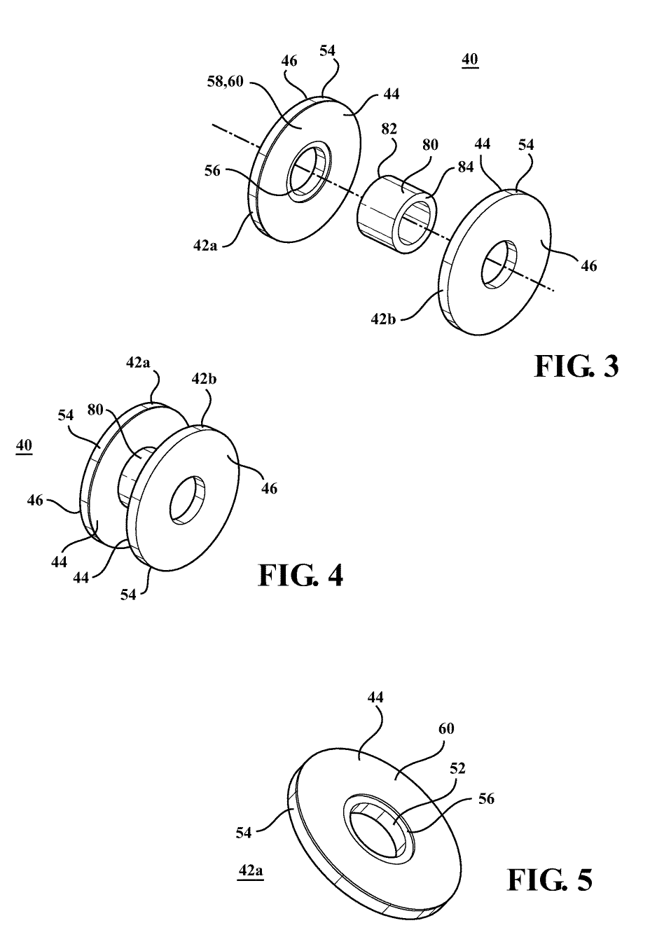

Referring also to FIGS. 3-5, the thrust washer sub-assembly 40 transfers shaft axial loads to the thrust bearing 100. The thrust washer sub-assembly 40 includes a first thrust washer 42a, a second thrust washer 42b, and a cylindrical thrust bearing spacer 80. Each of the first thrust washer 42a and second thrust washer 42b are a thin, flat plate having a center through-opening 52 and a peripheral edge 54 that defines a circular profile. One side 44 of each thrust washer 42a, 42b defines an inward face, or “thrust face” that abuts the thrust bearing spacer 80 and the thrust bearing 100. The side 46 of each thrust washer 42a, 42b opposed to the thrust face 44 defines an outward face. The outward face 46 of the first thrust washer 42a abuts the flinger sleeve 22, and the outward face 46 of the second thrust washer 42b abuts the shoulder 6a of the shaft 6.

The first and second thrust washers 42a, 42b are formed of a first material, and a portion of the thrust face 44 is provided with a lining 60 formed of a second material (FIG. 5). As used herein, the term “lining” refers to a material that covers or that is used to cover a surface of an object. The term “lining” is interchangeable with the terms “coating” and “plating,” and may be formed on the thrust face 44 using conventional techniques including, but not limited to, roll bonding.

The lining 60 is provided on only a portion of the thrust face 44 of each of the first and second thrust washers 42a, 42b. In particular, the lining 60 is provided at the interface between the thrust face 44 of each thrust washer 42a, 42b and the thrust bearing 100, whereby the lining 60 extends between the peripheral edge 54 and an annular, lining-free region 56 that adjoins the center through-opening 52. More particularly, the peripheral edge 54 has a radius of r1, the lining-free region 56 has a radius of r2 where the lining-free region radius r2 is less than the peripheral edge radius r1, and the center through-opening 52 has a radius of r3 where the center through-opening radius r3 is less than the lining-free region radius r2. The lined region 58 (e.g., the region between the peripheral edge 54 and the lining-free region 56) is large relative to the lining-free region 56. For example, in the illustrated embodiment, (r1−r2) is approximately 3*(r2−r3).

In the illustrated embodiment, the first material (e.g., the material used to form the thrust washers 42a, 42b) is steel, for example AISI 4140 or other hardenable steel. The second material (e.g., the material used to form the lining) is bronze (e.g., an alloy of 60% to 90% copper and 10% to 40% tin), brass (e.g., e.g., an alloy of about 50% copper and 5% to 40% zinc), or other material (for example, an alloy of aluminum and tin) having properties suitable for a bearing surface, including hardness, strength, and a low metal-on-metal coefficient of friction relative to the first material.

The thrust bearing spacer 80 is formed of steel, and has an inner diameter dimensioned to receive the shaft 6 therein with minimal clearance, and an outer diameter that is equal to or less than the radius r2 of the lining-free region 56. The thrust bearing spacer 80 also includes opposed axial-end faces 82, 84. The thrust bearing spacer 80 is interposed between the first and second thrust washers 42a, 42b, and serves to maintain a predetermined axial spacing between the first and second thrust washers 42a, 42b. In particular, the axial-end faces 82, 84 abut the respective thrust face 44 of each of the first and second thrust washers 42a, 42b within the lining-free region 56. Thus, the axial load, due to clamping the compressor wheel 5 against the shaft shoulder 6a via the nut 21, is transferred from the thrust bearing spacer 80 to the respective thrust washers 42a, 42b in the lining-free region 56. Since no lining is interposed between the axial-end faces 82, 84 of the thrust bearing spacer 80 and the thrust washers 42a, 42b, a hardened steel-steel interface is provided. This is advantageous since the hardened steel is capable of carrying higher compressive stress than the lining material. For example, the yield strength of the hardened steel components may be in the order of 640 MPa, and depending on the specific design, the compressive loads may be beyond the capability of some lining materials.

In the illustrated embodiment, the thrust washer sub-assembly 40 includes the first thrust washer 42a, the second thrust washer 42b and the thrust bearing spacer 80 that are formed separately, and then assembled with the shaft 6 in the above-described configuration at the time of manufacture of the turbocharger 1 (FIG. 3). However, in other embodiments, the first and second thrust washers 42a, 42b and the thrust bearing spacer 80 are pre-assembled into the above-described sub-assembly 40 prior to building the turbocharger 1 (FIG. 4). Providing the first and second thrust washers 42a, 42b and the thrust bearing spacer 80 as a pre-assembled unit ensures that these each of these components are assembled in the correct orientation (for example, with the respective thrust faces 44 facing the thrust bearing spacer 80). In addition, any adhesive used, for instance, to hold the components in the pre-assembled configuration, would only be needed until the sub-assembly had been assembled with the turbocharger. Thereafter, the rotor clamping load would retain the sub-assembly in the desired configuration. In still other embodiments, the first and second thrust washers 42, 62 and the thrust bearing spacer 80 are formed as a single, monolithic element that can be assembled as a unit with the shaft 6 at the time of manufacture of the turbocharger 1.

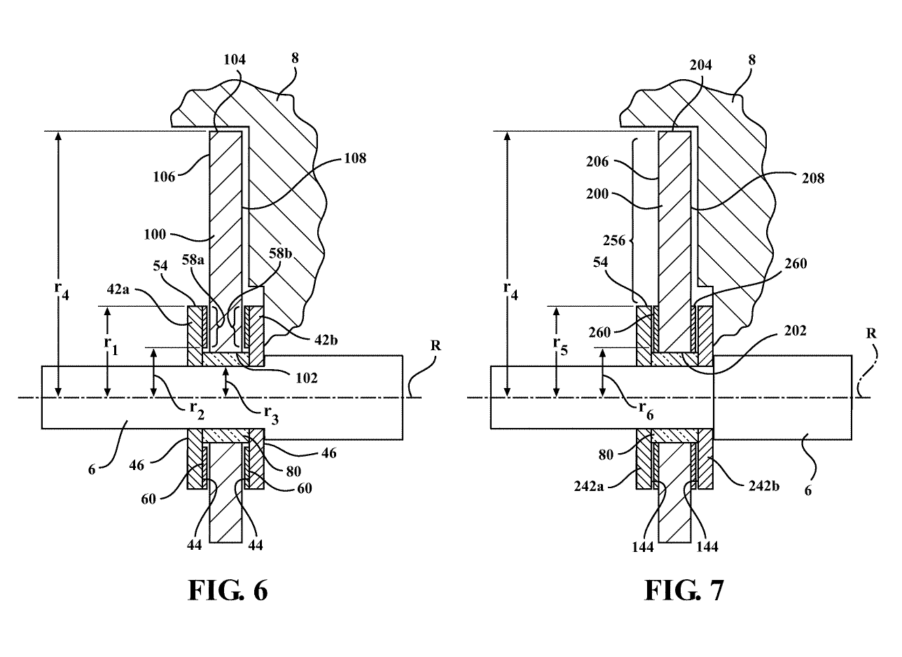

Referring to FIG. 6, the thrust bearing 100 is a thin, flat plate having a center through-opening 102 and a peripheral edge 104 that defines a circular profile. The thrust bearing 100 further includes load-transmitting surfaces 106, 108 that extend between the peripheral edge 104 and the center through-opening 102. Specifically, the thrust bearing 100 has compressor-facing surface 106, and an opposed turbine-facing surface 108. The center through-opening 102 is dimensioned to correspond to the outer diameter of the thrust bearing spacer 80, and the thrust bearing 100 is supported on the outer surface of the thrust bearing spacer 80. The thrust bearing 100 is stationary and held against the bearing housing 8. The thrust bearing 100 has an anti-rotation feature. For example, the thrust bearing may be pegged to prevent rotation relative to center bearing housing 8 and the thrust washer sub assembly 40. The thrust bearing 100 is large relative to the first and second thrust washers 42a, 42b. In the illustrated embodiment, the thrust bearing 100 has a radius r4 that is about 2.5 times the radius r1 of the first and second thrust washers 42a, 42b. Shaft axial loads are transmitted to the thrust bearing 100 via the lining 60 formed on the thrust face 44 of the respective thrust washers 42a, 42b. The outer periphery of the thrust bearing 100, which includes the peripheral edge 104 and portions of the compressor-facing and turbine-facing surfaces 106, 108 immediately adjacent to the peripheral edge 104, is supported between the bearing housing cover 19 and the center bearing housing 8, whereby the turbine-facing surface 108 transmits the shaft axial loads to the bearing housing 8.

Although the thrust washer subassembly 40 includes thrust washers 42a, 42b in which the thrust face 44 is partially lined, the thrust washer assembly 40 is not limited to this configuration. For example, in some embodiments, the lining-free region of the thrust washers 42a, 42b may be omitted whereby the entire thrust face 44 of the thrust washer 42a, 42b is lined.

In the illustrated embodiment, the thrust bearing 100 is formed of steel, which is stronger and less expensive than copper. By providing a steel thrust bearing 100, the thrust bearing assembly 20, and thus also the turbocharger 1, can be made smaller. Alternatively, the turbocharger 1 including the steel thrust bearing 100 can accommodate higher axial loads.

The thrust bearing assembly 20 includes the steel thrust bearing 100 in conjunction with the steel thrust washers 42a, 42b having a lining 60 of a material that is soft and has a low coefficient of friction relative to the material used to form the thrust washers 42a, 42b. However, the thrust bearing assembly 20 is not limited to this configuration. For example, in other embodiments, the thrust bearing assembly 20 includes a steel thrust bearing 200 having a lining or lining 260 of a material that is soft and has a low coefficient of friction relative to the material used to form the thrust bearing 200 (FIG. 7). The lining 260 is provided on only a portion of each of the thrust bearing surfaces 206, 208. In particular, the lining 260 is provided at the interface between the thrust bearing 200 and the thrust face 44 of each thrust washer 42a, 42b, whereby the lining 260 extends between the center through-opening 202 and an annular, lining-free region 256 that adjoins the peripheral edge 204 (FIG. 8). More particularly, the peripheral edge 204 has a maximum radius of r4, the lined region 258 (e.g., the region between the center through-opening 202 and the lining-free region 256) has a radius of r5 where the lined-region radius r5 is less than the peripheral edge radius r4, and the center through-opening 202 has a radius of r6 where the center through-opening radius r6 is less than the lined region radius r5. The lined region 258 is small relative to the lining-free region 256. For example, in the illustrated embodiment, (r4−r5) is approximately 4*(r5−r6) at at least one location of the respective bearing surface 206, 208, e.g., at a location corresponding to the maximum radius r4.

Although the thrust bearing 200 illustrated in FIG. 7 includes thrust bearing surfaces 206, 208 that are partially lined, the thrust bearing 200 is not limited to this configuration. For example, in some embodiments, the lining-free region may be omitted whereby the entire thrust bearing surfaces 206, 208 of the thrust bearing 200 are lined.

Referring again to FIG. 2, the lubrication system for the turbocharger journal bearings 7a, 7b and thrust bearing assembly 20 is formed in the bearing housing 8. In the illustrated configuration, pressure fed oil is received by the bearing housing 8 though an oil inlet 70 from the engine. The oil is pressure fed through oil galleries 72, 74, 76 that connect the oil inlet 70 to the bearing housing 8 and journal bearing bore 8a. For both the turbine-end and compressor-end journal bearings 7a, 7b, the oil flow is delivered to the journal bearing zones at which points the oil is distributed around the shaft 6 to generate an oil film between the shaft surface 6d and the inner bore of the floating journal bearings 7a, 7b. On the outside of the journal bearings 7a, 7b, a like oil film is generated by the rotation of the journal bearing against the bearing housing journal bearing bore 8a. The oil is delivered to both sides of the journal bearings (7a, 7b), via the oil galleries 72, 74 to provide the oil film, referred to as a “double hydrodynamic squeeze film,” the pressures of which exert reactionary forces of the shaft on the ID of the bearing and of the OD of the bearing on the bearing housing bore 8a. The oil films provide attenuation of the reactionary forces to reduce the amplitude of the excursions of the shaft. The oil also functions to remove heat from the turbocharger as the oil drains through the oil drain 78 to the crankcase of the engine.

In the turbocharger depicted in FIG. 1, the thrust bearing 100 is also a hydrodynamic or fluid film type of bearing. In this configuration, the stationary thrust bearing 100 is fed oil from the oil gallery 76 to feed a ramp and pad design of bearing. The oil is driven into a wedge shape by the relative motion of the thrust washer 100 and the thrust washer area of the flinger sleeve 22, which rotates along with the shaft, against the static thrust ramp and pad. The thrust bearing 100 controls the axial position of the rotating assembly. For an exemplary 76 mm turbine wheel—sized turbocharger, the oil flow is provided at a rate of about 4200 to 6200 grams per minute.

Although particular preferred embodiments of the invention have been disclosed in detail for illustrative purposes, it will be recognized that variations or modifications of the disclosed apparatus, including the rearrangement of parts, lie within the scope of the present invention.

1. A washer formed of a first material, the washer comprising
a first face,
a second face opposed to the first face,
a peripheral edge extending between the first face and the second face along a circumference of the washer, and
a through-opening surrounded by the peripheral edge and defining an inner edge, wherein
the first face includes a lining of a second material that is different from the first material, and
the second face is free of a lining of the second material.

2. The washer of claim 1 wherein the lining extends between the peripheral edge and an annular, lining-free region that adjoins the inner edge.

3. The washer of claim 2 wherein
the peripheral edge has a radius of r1,
the lining-free region has a radius of r2,
r2 is less than r1,
the inner edge has a radius of r3,
r3 is less than r2, and
(r1−r2) is approximately 3*(r2−r3).

4. The washer of claim 1 wherein the second material is softer than the first material and has a lower coefficient of friction than the first material.

5. A thrust bearing formed of a first material, the thrust bearing comprising
a first face,
a second face opposed to the first face,
a peripheral edge extending between the first face and the second face along a circumference of the thrust bearing, and
a through-opening surrounded by the peripheral edge and defining an inner edge, wherein
the first face and the second face include a lining of a second material that is different from the first material.

6. The thrust bearing of claim 5 wherein a portion of the first face and the second face includes the lining, and
the portion extends between the inner edge and an annular, lining-free region that adjoins the peripheral edge.

7. The thrust bearing of claim 6 wherein
the peripheral edge has a maximum radius of r4,
the lining has a radius of r5,
r5 is less than r4,
the inner edge has a radius of r6,
r6 is less than r5, and
(r4−r5) is approximately 4*(r5−r6).

8. The thrust bearing of claim 5 wherein the second material is softer than the first material and has a lower coefficient of friction than the first material.

9. A turbocharger comprising
a compressor wheel;
a turbine wheel;
a shaft that connects the compressor wheel to the turbine wheel;
a bearing housing that rotatably supports the shaft and includes a thrust bearing assembly, the thrust bearing assembly comprising
a first thrust washer and a second thrust washer, each of the first thrust washer and the second thrust washer being mounted on the shaft, formed of a first material and including
a first face, and
a second face that is opposed to the first face,
a hollow, cylindrical spacer disposed on the shaft between the first thrust washer and the second thrust washer, the spacer having a first end that abuts the first face of the first thrust washer and a second end opposed to the first end, the second end abutting the first face of the second thrust washer, and
a thrust bearing that is formed of the first material and includes
a first thrust surface,
a second thrust surface that is opposed to the first thrust surface, and
a center through-opening that is dimensioned to correspond to an outer diameter of the spacer, the thrust bearing receiving the spacer within the through-opening,
wherein
the first thrust surface and the first face of the first thrust washer abut in a first region, and the second thrust surface and the first face of the second thrust washer abut in a second region, and
one of the thrust bearing and the first and second thrust washers includes a lining formed of a second material, where the lining is provided in the first region and in the second region, and the remainder of the thrust bearing or the first and second thrust washers is lining free.

10. The turbocharger of claim 9, wherein each of the first thrust washer and the second thrust washer include
a peripheral edge extending between the first face and the second face along a circumference of the thrust washer, and
a through-opening surrounded by the peripheral edge and defining an inner edge,
wherein the lining is provided on the first face and extends between the peripheral edge and an annular, lining-free region that adjoins the inner edge.

11. The turbocharger of claim 10 wherein
the peripheral edge has a radius of r1,
the lining-free region has a radius of r2,
r2 is less than r1,
the inner edge has a radius of r3,
r3 is less than r2, and
(r1−r2) is approximately 3*(r2−r3).

12. The turbocharger of claim 9, wherein the thrust bearing includes a peripheral edge extending between the first thrust surface and the second thrust surface along a circumference of the thrust bearing, and
the through-opening is surrounded by the peripheral edge and defines an inner edge,
wherein the lining is provided on the first thrust surface and the second thrust surface, and extends between the inner edge and an annular, lining-free region that adjoins the peripheral edge.

13. The turbocharger of claim 12 wherein
the peripheral edge has a maximum radius of r4,
a region corresponding to the lining has a radius of r5,
r5 is less than r4,
the inner edge has a radius of r6,
r6 is less than r5, and
(r4−r5) is approximately 4*(r5−r6).

14. The bearing assembly of claim 9 wherein the spacer is fixed to each of the first thrust washer and the second thrust washer so as to form a pre-assembled unit.

15. The bearing assembly of claim 9 wherein the second material is softer than the first material and has a lower coefficient of friction than the first material.
